(19) United States
(12) Patent Application Publication
(10) Pub. No.: US 2014/0320030 A1
(43) Pub. Date: Oct. 30, 2014

(54) PROGRAMMABLE CONTROLLER OF LIGHT STRING

(71) Applicant: CHENG-YAO CHIANG, Hsinchu City (TW)

(72) Inventor: CHENG-YAO CHIANG, Hsinchu City (TW)

(21) Appl. No.: 13/869,931

(22) Filed: Apr. 24, 2013

(51) Int. Cl. H05B 37/02

(52) U.S. Cl. CPC H05B 37/02
USPC 315/185 R

(57) ABSTRACT

The present invention relates to a programmable controller of light string characterized in that the controller of light string is provided with a bluetooth receiver and a main IC electronically connected with the bluetooth receiver so as to further corporate with a smart phone to download a new song or music and then transmit it through the bluetooth of the smart phone to the bluetooth receiver. The rhythm of the new song or music is converted to signals by the main IC of the controller for controlling the flashing of all light bulbs at the corresponding rhythm. Thereby the light string is able to change the flashing pattern of light bulbs in association with the update of a song or music that varies the flashing effect of light string in a broad range of variety.

### TECHNICAL FIELD OF THE INVENTION

The present invention relates to an improved design for a light string able to flash at different patterns, and particularly to an improved structure of a programmable controller of the light string.

### DESCRIPTION OF THE PRIOR ART

A light string of the present invention is able to flash the light bulbs at different patterns. Currently the commercially available light string has a controller containing an IC embedded with few set of predetermined flashing patterns, songs or music in order to change the flashing pattern of light bulbs.

However the embedded songs or music are predetermined and unable to be updated or changed with different songs or music at demand. Therefore the light string of prior art is monotonous and rigid in terms of flashing pattern that is in need for an improvement.

### SUMMARY OF THE INVENTION

An objective of the present invention is to resolve the deficiency of monotonous and rigid flashing patterns exist in a light string of prior art with an improvement to change the flashing patterns in association with the update of different songs or music through a smart phone. Thus the flashing patterns become varying in a broad range of variety.

A programmable controller of light string for achieving the aforesaid objective of the present invention is to provide a bluetooth receiver electronically connected with the main IC in the controller of light string such that a new song or music can be downloaded by a smart phone and then transmitted through the bluetooth of the smart phone to the bluetooth receiver.

The rhythm of the new song or music is therefore converted to signals by the main IC in order to control the flashing of all light bulbs in a rhythm pattern. Thereby the light string is able to flash at different patterns in association with different songs or music that varies the flashing effect of light string in a broad range of variety.

### BRIEF DESCRIPTION OF THE DRAWINGS

FIG. 1 is a schematic diagram of elements and arrangement illustrating a preferred embodiment of the present invention.

### DETAILED DESCRIPTION OF THE PREFERRED EMBODIMENTS

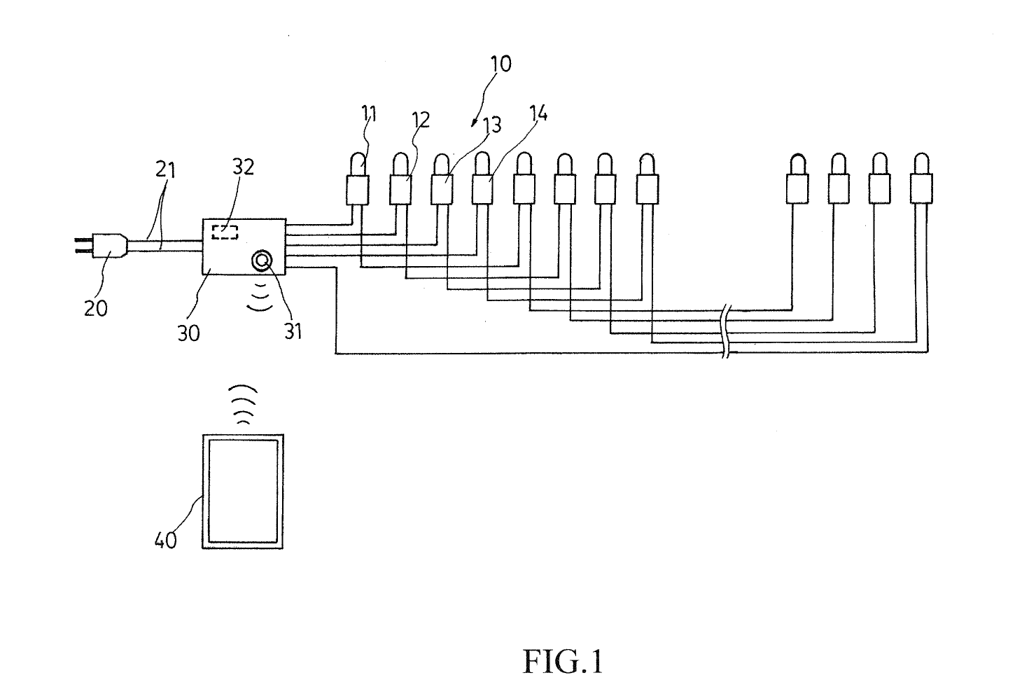

FIG. 1 is a schematic diagram of elements and arrangement illustrating a preferred embodiment for the programmable controller of light string of the present invention. The light string (10) is provided with a plug (20) for connecting to an electricity supply, the plug (20) is connected to a controller (30) through a electrical wire (21) and the controller (30) is connected to four groups of light sources (11), (12), (13) and (14) consisting of a plurality of light bulbs through conducting wires. The character is that the controller (30) of light string (10) is provided with a bluetooth receiver (31) and a main IC (32) electronically connected with the bluetooth receiver (31) so as to further corporate with a smart phone (40) for downloading a new song or music and then transmitting it through the bluetooth of the smart phone (40) to the bluetooth receiver (31) in the controller (30) of the light string (10). The rhythm of the new song or music is therefore converted to signals by the main IC (32) of the controller (30) for controlling the flashing of all light bulbs at the corresponding rhythm. Thereby the light string (10) is able to change the flashing pattern of light bulbs in association with the update of songs or music through the smart phone (40) that varies the flashing effect of light string (10) in a broad range of variety.

I claim:

1. A programmable controller of a light string, the light string is provided with a plug for connecting to an electricity supply, the plug is connected to a controller through an electrical wire, the controller is connected to four groups of light sources consisting of a plurality of light bulbs through conducting wires, characterized in that the controller is provided with a bluetooth receiver and a main IC electronically connected with said bluetooth receiver so as to further corporate with a smart phone for downloading a new song or music and transmitting the new song or music through the bluetooth of the smart phone to said bluetooth receiver for converting the rhythm of the new song or music to signals by said main IC for controlling the flashing of all light bulbs at corresponding rhythm, thereby the light string is able to change the flashing pattern of light bulbs in association with the update of songs or music through the smart phone.
